(19) United States
(12) Patent Application Publication
(10) Pub. No.: US 2020/0194894 A1
(43) Pub. Date: Jun. 18, 2020

(54) ANTENNA DEVICE

(71) Applicant: MITSUBISHI ELECTRIC CORPORATION, Tokyo (JP)

(72) Inventors: Takashi YANAGI, Tokyo (JP); Yasuhiro NISHIOKA, Tokyo (JP); Atsuhiko NAGAMUNE, Tokyo (JP)

(73) Assignee: MITSUBISHI ELECTRIC CORPORATION, Tokyo (JP)

(21) Appl. No.: 16/615,007

(22) PCT Filed: Jun. 23, 2017
(86) PCT No.: PCT/JP2017/023189

§ 371 Date: Nov. 19, 2019

(51) Int. Cl. H01Q 9/04; H01Q 1/42; H01Q 1/50

(52) U.S. Cl. CPC H01Q 9/045; H01Q 1/50; H01Q 1/42

(57) ABSTRACT

A metal housing (1) has an aperture (1a). A first conductor (3a) is disposed in a portion except for the aperture (1a) of the metal housing (1), and is capacitively coupled to the metal housing (1). A second conductor (3b) is a conductor transparent to visible light, and is disposed in the aperture (1a) of the metal housing (1). An AC voltage is applied to the first conductor (3a) and the second conductor (3b).

### TECHNICAL FIELD

The present invention relates to an antenna device that is transparent to visible light.

### BACKGROUND ART

A transparent conductive material is a medium that has conductivity while being optically transparent. It is possible to obtain an invisible or inconspicuous antenna device by using a transparent conductive material for an antenna. Normally, the performance of an antenna depends on its size. Therefore, it is possible to improve the performance of an antenna by forming a wide antenna conductor using a transparent conductive material. For example, there has been an antenna device in which a radiation element, a ground element, and a parasitic element are formed with transparent conductive materials having light transmittances of equal to or higher than 80% to improve visibility (see Patent Literature 1, for example).

### CITATION LIST

### Patent Literature

Patent Literature 1: JP 2016-10042 A

### SUMMARY OF INVENTION

### Technical Problem

The conductivity of a transparent conductive material becomes lower as the light transmittance thereof becomes higher, and is about 100 times lower than that of copper or aluminum, which is metal often used for an antenna element. Therefore, there is a problem in that, in the above conventional antenna device, if a transparent conductive material having a high light transmittance is used to improve visibility, the radiation efficiency of the antenna is reduced due to the low conductivity.

The present invention has been made to solve the problem and aims to provide an antenna device that can obtain a high radiation efficiency even when using a transparent conductive material having low conductivity.

### Solution to Problem

An antenna device according to the present invention includes: a metal housing having an aperture; a first conductor disposed in a portion except for the aperture of the metal housing, the first conductor being capacitively coupled to the metal housing; and a second conductor disposed in the aperture of the metal housing and in a same plane as that of the first conductor between which an alternating-current voltage is applied, the second conductor being transparent to visible light.

### Advantageous Effects of Invention

An antenna device according to the present invention includes: a first conductor that is capacitively coupled to a metal housing; and a second conductor that is disposed in the aperture of the metal housing and is transparent to visible light. Thus, a high radiation efficiency can be achieved even with a transparent conductive material having low conductivity.

### BRIEF DESCRIPTION OF DRAWINGS

FIG. 1 is a configuration diagram of an antenna device according to a first embodiment of the present invention.

FIG. 2 is a cross-sectional view taken along line A-A in FIG. 1.

FIG. 3A and FIG. 3B are configuration diagrams showing modifications of a second conductor in the antenna device according to the first embodiment of the present invention.

FIG. 4 is a configuration diagram of an antenna device according to a second embodiment of the present invention.

FIG. 5 is a configuration diagram of a conductor in the antenna device according to the second embodiment of the present invention.

FIG. 6 is a configuration diagram of an antenna device according to a third embodiment of the present invention.

FIG. 7 is a cross-sectional view taken along line B-B in FIG. 6.

FIGS. 8A and 8B are configuration diagrams showing a feed substrate in the antenna device according to the third embodiment of the present invention.

FIG. 9 is a configuration diagram of a modification of the antenna device according to the third embodiment of the present invention.

### DESCRIPTION OF EMBODIMENTS

To explain the present invention in greater detail, modes for carrying out the invention are described below with reference to accompanying drawings.

### First Embodiment

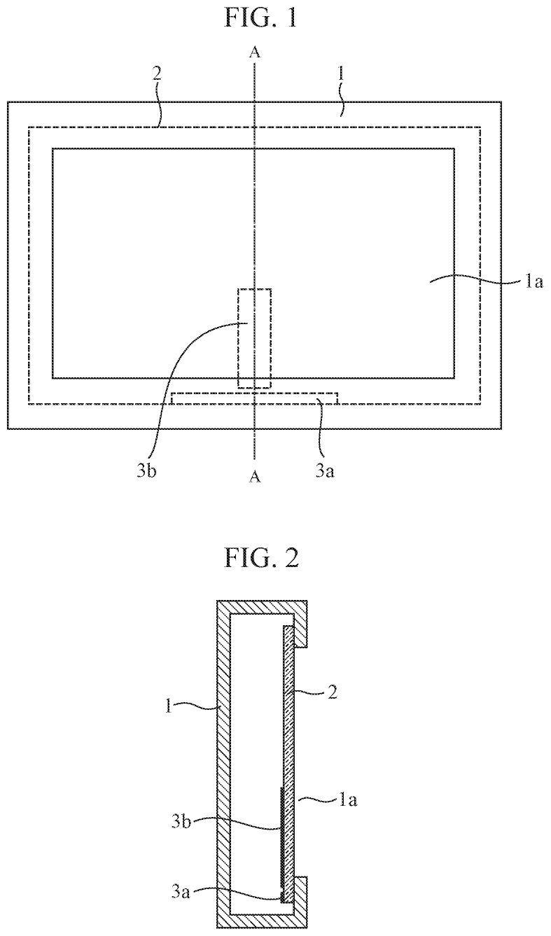

FIG. 1 is a configuration diagram of an antenna device according to this embodiment, and FIG. 2 is a cross-sectional view taken along line A-A in FIG. 1.

As shown in FIGS. 1 and 2, the antenna device according to this embodiment includes a metal housing 1, a glass 2, a first conductor 3a, and a second conductor 3b. The metal housing 1 is made of metal such as aluminum, is formed in a box-like shape to accommodate a liquid crystal display, a control board, and a communication board (which are not shown) therein, and has an aperture 1a on the front.

The glass 2 is a plate-like glass that is held by the metal housing 1 and is disposed to cover the aperture 1a of the metal housing 1. The glass 2 protects the liquid crystal display and the like in the metal housing 1. Further, the glass 2 forms a dielectric having a predetermined dielectric constant.

The first conductor 3a and the second conductor 3b are transparent conductive films bonded to the surface of the glass 2 on the opposite side with respect to a surface in contact with the metal housing 1. A transparent conductive film (also referred to as a transparent electrode) is a sheet-like medium that is transparent to visible light and has conductivity. Normally, the higher the light transmittance of a transparent conductive film (the higher the transparency) is, the higher the sheet resistance becomes. In this embodiment, transparent conductive films having a sheet resistance value of 5 to 50 Ω/sq and a light transmittance of 70 to 80% are used, for example.

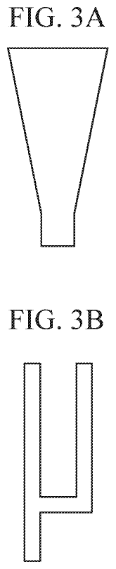

Most of the second conductor 3b is disposed in the aperture 1a of the metal housing 1, and only an edge portion thereof is located on a frame portion of the metal housing 1 (the edge portion of the second conductor 3b is hidden behind the frame of the metal housing 1 when viewed from the front). The first conductor 3a is disposed to be located on the frame portion of the metal housing 1 via the glass 2, and has a very narrow space between itself and the second conductor 3b. For example, a coaxial cable (not shown) is electrically connected to this space for high-frequency signals. In other words, the inner conductor of the coaxial cable is connected to the second conductor 3b, and the outer conductor of the coaxial cable is connected to the first conductor 3a. With this, an AC voltage is applied between the first conductor 3a and the second conductor 3b. Note that a transmission line that is not a coaxial cable may be selected, as long as a desired AC voltage can be applied between the first conductor 3a and the second conductor 3b. Further, although the second conductor 3b shown in FIG. 1 has a strip shape, any desired shape may be selected, as long as the second conductor 3b is designed to resonate at a desired frequency. For example, it is possible to select a shape whose width gradually widens as shown in FIG. 3A, a shape having a branch as shown in FIG. 3B, or the like.

Next, operation of the antenna device according to the first embodiment of the present invention is described. As there is reciprocity between a transmitting antenna and a receiving antenna, operation of the antenna device as a transmitting antenna is described herein.

When an AC voltage is applied between the first conductor 3a and the second conductor 3b, charge transfer occurs between them, and an AC current flows. At this stage, the second conductor 3b becomes a monopole antenna element designed to resonate at a desired frequency, and emits radio waves. Further, the first conductor 3a is disposed to overlap the metal housing 1 via the glass 2. Therefore, when an AC current flows in the first conductor 3a, the AC current also flows in the metal housing 1 because of capacitive coupling. In other words, the metal housing 1 operates as the ground of the monopole antenna formed with the second conductor 3b. As a result, the ground of the antenna can be secured sufficiently large, and concentration of current onto the transparent conductive films can be prevented. Thus, loss due to the low conductivity of the transparent conductive films can be reduced.

Normally, when a metallic material approaches in parallel with the current flowing in an antenna, a current of the opposite phase is induced in the approaching metallic material, resulting in a decrease in the radiation efficiency of the antenna. Therefore, if an antenna is provided inside a metal housing, the radiation efficiency of the antenna is reduced. In the antenna device of the first embodiment, on the other hand, the second conductor 3b to be a monopole antenna element is provided in the aperture 1a of the metal housing 1, and thus, it is possible to prevent a reduction in the radiation efficiency. Further, as the second conductor 3b is formed with a transparent conductive film, the second conductor 3b disposed in the aperture 1a of the metal housing 1 does not lower the visibility. Furthermore, as the space between the second conductor 3b and the first conductor 3a is located in a portion hidden by the metal housing 1, a transmission line such as a coaxial cable connected thereto does not lower the visibility.

Moreover, as the first conductor 3a and the metal housing 1 are not in physical contact with each other, the ground (signal ground) of the control board and the like connected to the monopole antenna formed with the second conductor 3b can be separated from the ground (frame ground) of the metal housing 1.

As described above, an antenna device according to the first embodiment includes: a metal housing that has an aperture; a first conductor that is disposed in a portion other than the aperture of the metal housing and is capacitively coupled to the metal housing; and a second conductor that is disposed in the aperture of the metal housing and in the same plane as that of the first conductor, and is transparent to visible light, to which an alternating-current voltage is applied between the first conductor and the second conductor. Thus, it is possible to provide an antenna element without lowering visibility. Further, it is possible to use the metal housing as the ground of the antenna, while keeping the frame ground and the signal ground separated from each other. Thus, it is possible to obtain an antenna device that has a high radiation efficiency, even though the antenna is disposed inside the metal housing.

Further, in the antenna device according to the first embodiment, at least the second conductor of the first and second conductors is a transparent conductive film, so that it is possible to obtain an antenna device with improved visibility.

### Second Embodiment

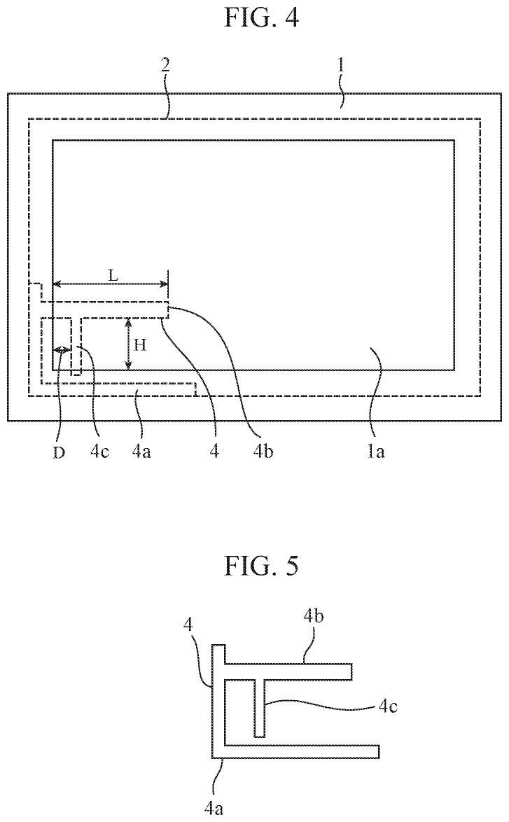

FIG. 4 is a configuration diagram showing an antenna device according to a second embodiment. The metal housing 1 and the glass 2 in FIG. 4 are the same as those of the first embodiment. Therefore, the corresponding components are denoted by the same reference numerals as those used in the first embodiment, and explanation thereof is not made herein.

The difference between the antenna device of the second embodiment and the antenna device of the first embodiment is that the first conductor 3a and the second conductor 3b of the first embodiment are replaced with a conductor 4 formed with one transparent conductive film. As shown in FIGS. 4 and 5, the conductor 4 includes a third conductor 4a formed in an L shape along one corner portion of the aperture 1a of the metal housing 1, a fourth conductor 4b parallel to the third conductor 4a, and a fifth conductor 4c perpendicular to the third conductor 4a. In the antenna device of the second embodiment, an AC voltage is applied between the third conductor 4a and the fifth conductor 4c. At this stage, the length L of the fourth conductor 4b exposed through the aperture 1a (the length from an open end of the aperture 1a to the tip of the fourth conductor 4b), the length H of the fifth conductor 4c exposed through the aperture 1a (the length from an open end of the aperture 1a to the base portion of the fifth conductor 4c), and a distance D between an open end of the aperture 1a and the fifth conductor 4c are properly designed, so that the conductor 4 operates as an inverted-F antenna that resonates at a desired frequency.

An inverted-F antenna is an antenna system that can reduce the height and broaden the bandwidth of an antenna by providing a short circuit line (short stub) to the ground near the voltage application unit of an inverted-L antenna obtained by bending a monopole antenna. The third conductor 4a of the conductor 4 is the ground of the inverted-F antenna. However, the third conductor 4a is disposed along a corner portion of the metal housing 1 to overlap the metal housing 1 via the glass 2, and is capacitively coupled to the metal housing 1. Because of this, the metal housing 1 operates as the antenna ground. Thus, it is possible to reduce loss due to the low conductivity of the transparent conductive film, as in the antenna device of the first embodiment.

Further, as the conductor 4 serving as the inverted-F antenna is disposed in the aperture 1a of the metal housing 1, it is possible to prevent a reduction in the radiation efficiency without lowering the visibility, as in the operation described in the first embodiment.

Furthermore, as the inverted-F antenna of this embodiment is integrally formed with one transparent conductive film, there is no need to provide a new short circuit line. Thus, the manufacture can be simplified, and the costs can be reduced.

As described above, an antenna device according to the second embodiment includes: a metal housing that has an aperture; a third conductor that is disposed in a portion other than the aperture of the metal housing, is bent along a corner portion of the aperture, and is capacitively coupled to the metal housing; a fourth conductor that is disposed in the aperture of the metal housing and in the same plane as that of the third conductor and that is transparent to visible light; and a fifth conductor that is disposed in the aperture of the metal housing and in the same plane as that of the third conductor, is perpendicular to the fourth conductor, and is transparent to visible light, to which an alternating-current voltage is applied between the third conductor and the fifth conductor. The fourth conductor and the fifth conductor form an inverted-F antenna by being sequentially connected to the third conductor. Accordingly, an antenna can be disposed in an aperture of a housing having a small aperture, and an antenna device that has a small size and broadband characteristics can be obtained.

Further, in the antenna device according to the second embodiment, at least the fourth conductor and the fifth conductor of the inverted-F antenna are formed with a transparent conductive film. Thus, it is possible to obtain an antenna device with improved visibility.

### Third Embodiment

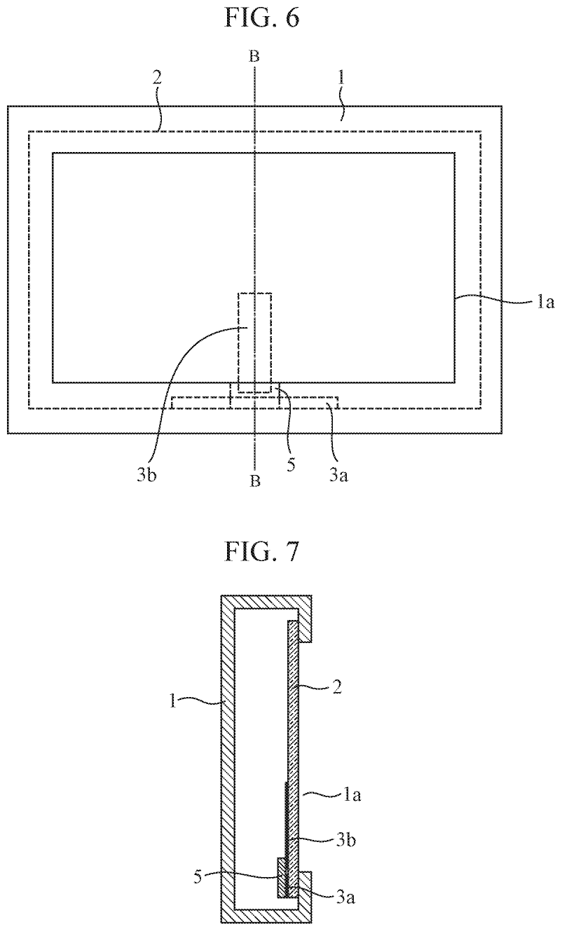

FIG. 6 is a configuration diagram of an antenna device according to a third embodiment, and FIG. 7 is a cross-sectional view taken along line B-B in FIG. 6. The configurations of the metal housing 1, the glass 2, the first conductor 3a, and the second conductor 3b in these diagrams are the same as those of the first embodiment. Therefore, the corresponding components are denoted by the same components as those used in the first embodiment, and explanation thereof is omitted herein.

An antenna device of the third embodiment includes a feed substrate 5 in addition to the components of the first embodiment. The feed substrate 5 is in physical contact with the first conductor 3a and the second conductor 3b, and is disposed in a portion overlapping the metal housing 1 (a portion that is not of the aperture 1a). The feed substrate 5 functions as an interface between the first and second conductors 3a and 3b, and a transmission line (not shown) such as a coaxial cable.

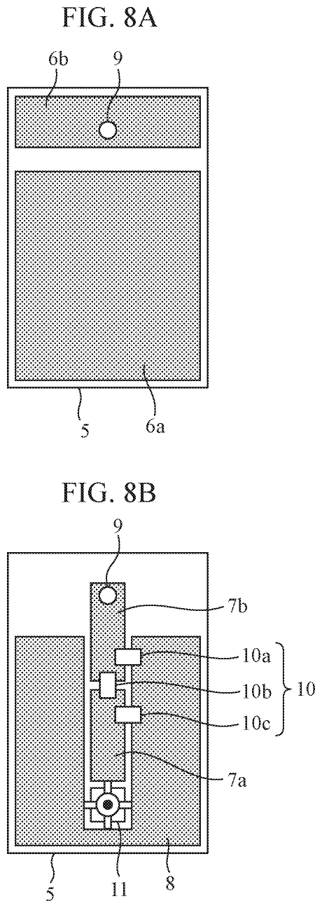

FIG. 8 is an explanatory view schematically showing an example of a conductor pattern on the feed substrate 5. FIG. 8A shows the front surface (a surface in contact with the first conductor 3a and the second conductor 3b), and FIG. 8B shows the back surface (a surface on the opposite side from the surface in contact with the first conductor 3a and the second conductor 3b). As shown in FIG. 8A, a first metal pattern 6a and a second metal pattern 6b are provided on the front surface side of the feed substrate 5. Further, as shown in FIG. 8B, a first signal line 7a and a second signal line 7b, a substrate ground 8, a through-hole 9, a matching circuit 10, and a connector 11 are provided on the back surface side.

On the feed substrate 5, the first metal pattern 6a is disposed to be in physical contact with the first conductor 3a, and the second metal pattern 6b is disposed to be in physical contact with the second conductor 3b. Meanwhile, the first signal line 7a and the second signal line 7b, and the substrate ground 8 constitute a coplanar line. Normally, the characteristic impedance of a coplanar line is set at 50Ω. The through-hole 9 is formed to connect the second metal pattern 6b and the second signal line 7b. The substrate ground 8 is preferably connected by a large number of through-holes (not shown), to have the same potential as the first metal pattern 6a in terms of radio frequency waves.

The first signal line 7a and the second signal line 7b are connected via the matching circuit 10. The matching circuit 10 is a circuit that includes circuit elements 10a, 10b, and 10c, and is provided to match the impedance of the monopole antenna formed with the second conductor 3b to the characteristic impedance of the first signal line 7a and the second signal line 7b. Chip inductors, chip capacitors, jumpers, or the like are used as the circuit elements. The connector 11 is a surface-mounted coaxial connector, for example, and its inner conductor is connected to the first signal line 7a.

If the depth of the metal housing 1 is small, or a liquid crystal display is disposed near the glass 2, the metal approaches parallel to the monopole antenna element formed with the second conductor 3b, and the impedance of the antenna is degraded. In this embodiment, on the other hand, the feed substrate 5 on which the matching circuit 10 is mounted is used to feed power to the antenna, so that the impedance of the antenna can be matched to the characteristic impedance of the transmission line, and the efficiency of the antenna can be improved.

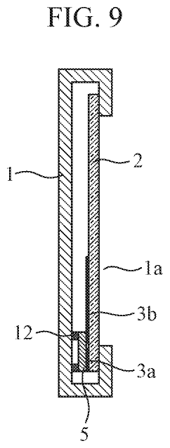

Further, as the monopole antenna element formed with the second conductor 3b and the transmission line such as a coaxial cable are connected via the feed substrate 5, there is no need to form a connection terminal such as a feed pad on the transparent conductive film. This can simplify the power feeding to the antenna. Furthermore, a spacer 12 is provided between the feed substrate 5 and the metal housing 1 as shown in FIG. 9, so that the electrical connection between the first and second metal patterns 6a and 6b, and the first and second conductors 3a and 3b on the feed substrate 5 can be made stronger.

As described above, an antenna device according to the third embodiment includes a first metal pattern connected to a first conductor, a second metal pattern connected to a second conductor, and a feed substrate for applying an alternating-current voltage to the first conductor and the second conductor via the first metal pattern and the second metal pattern. Thus, power feeding to the antenna can be simplified.

Further, in the antenna device according to the third embodiment, the feed substrate applies an alternating-current voltage to the second metal pattern via the matching circuit. Thus, the impedance of the antenna can be readily matched to the characteristic impedance of the transmission line. Accordingly, even in a case where it is not possible to set the impedance of an antenna at 50Ω due to a thin housing or the like, for example, the efficiency of the antenna can be improved.

Although an example in which a feed substrate is used in a monopole antenna formed with the first conductor and the second conductor of the first embodiment has been described above, the same effects as above can also be achieved with the inverted-F antenna of the second embodiment.

Specifically, an antenna device includes a first metal pattern connected to a third conductor, a second metal pattern connected to a fifth conductor, and a feed substrate for applying an alternating-current voltage to the third conductor and the fifth conductor via the first metal pattern and the second metal pattern. Thus, power feeding to the antenna can be simplified.

Further, in a case where a feed substrate is used in the second embodiment, the feed substrate applies an alternating-current voltage to the second metal pattern via the matching circuit. Thus, the impedance of the antenna can be readily matched to the characteristic impedance of the transmission line. Accordingly, even in a case where it is not possible to set the impedance of an antenna at 50Ω due to a thin housing or the like, for example, the efficiency of the antenna can be improved.

Note that, within the scope of the present invention, the embodiments may be freely combined, modifications may be made to any component of each embodiment, or any component may be omitted from each embodiment.

Further, in the first through third embodiments, the first conductor 3a, the second conductor 3b, and the third through fifth conductors 4a through 4c are each formed with a transparent conductive film. However, any material may be used, as long as the material is a conductor that is transparent to visible light.

### INDUSTRIAL APPLICABILITY

As described above, an antenna device according to the present invention relates to the configuration of an antenna transparent to visible light, and is suitably used as an antenna device to obtain a high radiation efficiency by using a transparent conductive material.

### REFERENCE SIGNS LIST

1: Metal housing, 1a: Aperture, 2: Glass, 3a: First conductor, 3b: Second conductor, 4: Conductor, 4a: Third conductor, 4b: Fourth conductor, 4c: Fifth conductor, 5: Feed substrate, 6a: First metal pattern, 6b: Second metal pattern, 7a: First signal line, 7b: Second signal line, 8: Substrate ground, 9: Through-hole, 10: Matching circuit, 11: Connector, 12: Spacer

1. An antenna device comprising:
a metal housing having an aperture;
a first conductor disposed in a portion except for the aperture of the metal housing, the first conductor being capacitively coupled to the metal housing; and
a second conductor disposed in the aperture of the metal housing and in a same plane as that of the first conductor between which an alternating-current voltage is applied, the second conductor being transparent to visible light.

2. The antenna device according to claim 1,
wherein, of the first conductor and the second conductor, at least the second conductor is a transparent conductive film.

3. The antenna device according to claim 1, further comprising: a feed substrate including a first metal pattern connected to the first conductor; and a second metal pattern connected to the second conductor, the feed substrate for applying an alternating-current voltage to the first conductor and the second conductor via the first metal pattern and the second metal pattern.

4. The antenna device according to claim 3, wherein the feed substrate applies an alternating-current voltage to the second metal pattern via a matching circuit.

5. An antenna device comprising:
a metal housing having an aperture;
a third conductor disposed in a portion except for the aperture of the metal housing, the third conductor being bent along a corner portion of the aperture, and the third conductor being capacitively coupled to the metal housing;
a fourth conductor disposed in the aperture of the metal housing and in a same plane as that of the third conductor, the fourth conductor being transparent to visible light; and
a fifth conductor disposed in the aperture of the metal housing and in a same plane as that of the third conductor between which an alternating-current voltage is applied, the fifth conductor being perpendicular to the fourth conductor and being transparent to visible light,
wherein the fourth conductor and the fifth conductor form an inverted-F antenna by being sequentially connected to the third conductor.

6. The antenna device according to claim 5,
wherein, in the inverted-F antenna, at least the fourth conductor and the fifth conductor are a transparent conductive film.

7. The antenna device according to claim 5, further comprising a feed substrate including a first metal pattern connected to the third conductor; and a second metal pattern connected to the fifth conductor, the feed substrate for applying an alternating-current voltage to the third conductor and the fifth conductor via the first metal pattern and the second metal pattern.

8. The antenna device according to claim 7,
wherein the feed substrate applies an alternating-current voltage to the second metal pattern via a matching circuit.
